(19) United States
(12) Patent Application Publication
(10) Pub. No.: US 2022/0127414 A1
(43) Pub. Date: Apr. 28, 2022

(54) METHOD FOR MANUFACTURING ELECTROLYTIC CAPACITOR

(71) Applicant: APAQ TECHNOLOGY CO., LTD., Miaoli County (TW)

(72) Inventor: CHIEH LIN, HSINCHU COUNTY (TW)

(21) Appl. No.: 17/201,216

(22) Filed: Mar. 15, 2021

(30) Foreign Application Priority Data
Oct. 26, 2020 (TW) 109137069

(51) Int. Cl. C08G 61/12; H01G 13/00; H01G 9/048; H01G 9/025

(52) U.S. Cl. CPC C08G 61/126; H01G 13/00; H01G 9/048; H01G 9/025; C08G 2261/122; C08G 2261/3243; C08G 2261/90; C08G 2261/1452; C08G 2261/143; C08G 2261/1426; C08G 2261/148; C08G 2261/514; C08G 2261/3247

(57) ABSTRACT

A method for manufacturing an electrolytic capacitor is provided. A conductive polymer solution is applied onto a porous main body. The porous main body includes a porous electrode body having an electrode material and a dielectric layer covering an outer surface of the electrode material. The conductive polymer solution contains conductive polymer particles whose average particle size ranges from 0.5 nm to 50 nm. A solid electrolyte is formed to completely or partially cover a surface of the dielectric layer. A material of the conductive polymer particles includes at least one of polythiophene having at least one sulfonic acid group and polyselenophene having at least one sulfonic acid group. An electrical conductivity of a dry membrane formed from the conductive polymer particles is higher than 25 S/cm. An amount of metal cations in the conductive polymer solution is less than 500 mg/kg.

### CROSS-REFERENCE TO RELATED PATENT APPLICATION

This application claims the benefit of priority to Taiwan Patent Application No. 109137069, filed on Oct. 26, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method for manufacturing a capacitor, and more particularly to a method for manufacturing an electrolytic capacitor.

### BACKGROUND OF THE DISCLOSURE

A commercially available solid electrolytic capacitor usually includes: a porous metal electrode, an oxide layer on a surface of the porous metal electrode, a solid electrolyte combined in a porous structure of the porous metal electrode, an electric connector, a package, and an external electrode (pin), such as a silver layer.

The solid electrolytic capacitor, for example, is prepared from a material of tantalum, aluminum, niobium, or niobium oxide. In addition, an electrons-transferred complex, pyrolusite, or polymer can also be used to prepare the solid electrolytic capacitor. The porous metal electrode has a high surface area, so that a capacitance density of the solid electrolytic capacitor can be enhanced. In other words, the solid electrolytic capacitor can have a high capacitance in a small volume.

A π-conjugated polymer has a high electrical conductivity, so that the π-conjugated polymer is suitable for being used as the solid electrolyte. The π-conjugated polymer is also called a conductive polymer or a synthesized metal. Generally, polymers have a better machinability, a lighter weight, and a higher chemically modifiable property than metals, so that an economic importance of the π-conjugated polymer has become increasingly prominent. The known π-conjugated polymer includes polypyrrole, polythiophene, polyaniline, polyacetylene, polyphenylene, and poly(p-phenylene-vinylene), among which polythiophene is particularly important. Poly(3,4-dioxyethylthiophene) is commonly applied in industry, and is also called poly(3,4-ethylenedioxothiophene). Poly(3,4-dioxyethylthiophene) has high electrical conductivity in an oxidized form.

The solid electrolytic capacitor having very low equivalent series resistance (ESR) has become essential to the technical development of the electronic field, which is due to a decrease of a voltage logic level, an increase of an integrated density, and an increase of a circulation frequency in integrated circuits. Further, low ESR reduces energy consumption, such that the solid electrolytic capacitor can be applied to mobile batteries. Therefore, efforts have been made to lower ESR of the solid electrolytic capacitor.

In the related art, a cationic polymer prepared from 3,4-dioxyethylthiophene through an oxidative polymerization is provided to form a solid electrolyte in the solid electrolytic capacitor. Poly(3,4-dioxyethylthiophene) is used to substitute for manganese dioxide or the electrons-transferred complex in the solid electrolytic capacitor due to the high electrical conductivity and the low ESR of poly(3,4-dioxyethylthiophene), so as to improve frequency properties.

In addition, a complex formed from poly(3,4-dioxyethylthiophene) and polystyrene sulfonate (PEDOT:PSS) has good electrical conductivity and low polymerization rate, and has thus been widely used. However, there are still some problems with PEDOT:PSS that need to be solved.

For example, PEDOT:PSS is generally produced through an in-situ polymerization. The PEDOT:PSS formed through the in-situ polymerization has a large particle size, such that PEDOT:PSS cannot fill into the porous metal electrode effectively. Accordingly, when a capacitor is immersed into a solution containing PEDOT:PSS, an immersion ratio of the capacitor is usually low.

Moreover, PEDOT:PSS absorbs water easily, and capacitor elements are sensitive to steam. Once steam in an environment is absorbed by PEDOT:PSS, electrical properties of the capacitor elements can be negatively influenced, or the capacitor elements may even malfunction. Therefore, when PEDOT:PSS is used as a material of the solid electrolyte, a package structure with good water-resistance is needed.

### SUMMARY OF THE DISCLOSURE

In response to the above-referenced technical inadequacies, the present disclosure provides a method for manufacturing an electrolytic capacitor.

In one aspect, the present disclosure provides a method for manufacturing an electrolytic capacitor. The method for manufacturing the electrolytic capacitor includes steps as follows. A conductive polymer solution is applied onto a porous main body. The porous main body includes a porous electrode body having an electrode material and a dielectric layer covering an outer surface of the electrode material. The conductive polymer solution contains conductive polymer particles. Then, a solid electrolyte is formed to completely or partially cover a surface of the dielectric layer. An amount of metal cations in the conductive polymer solution is less than 500 mg/kg. A material of the conductive polymer particles includes at least one of polythiophene having at least one sulfonic acid group and polyselenophene having at least one sulfonic acid group. An average particle size of the conductive polymer particles in the conductive polymer solution ranges from 0.5 nm to 50 nm. An electrical conductivity of a dry membrane formed from the conductive polymer particles is higher than 25 S/cm.

In certain embodiments, a particle size distribution D90 of the conductive polymer particles is smaller than 50 nm.

In certain embodiments, a particle size distribution D10 of the conductive polymer particles is larger than 0.5 nm.

In certain embodiments, an amount of transition metals in the conductive polymer solution is lower than 100 mg/kg.

In certain embodiments, an amount of iron metal in the conductive polymer solution is lower than 100 mg/kg.

In certain embodiments, the polythiophene having at least one sulfonic acid group is shown in formula (I) and the polyselenophene having at least one sulfonic acid group is shown in formula (II).

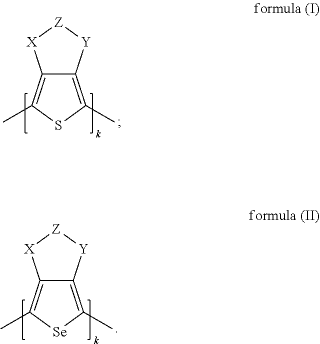

In formula (I) and formula (II), X and Y are each independently selected from the group consisting of: an oxygen atom, a sulfur atom, and —NR¹. R¹ is selected from the group consisting of: a hydrogen atom, an alkyl group having 1 to 24 carbon atoms, and an aromatic group having 4 to 16 carbon atoms. “k” is an integer ranging from 1 to 50.

In formula (I) and formula (II), “Z” is —(CH₂)ₘ—CR²R³—(CH₂)ₙ—. “R²” is selected from the group consisting of: a hydrogen atom, —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ. “R³” is selected from the group consisting of: —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR₄[Ar—SO₃⁻M⁺], and —(CH₂)ₚ—O—Ar—[(CH₂)_{q}—SO₃⁻M⁺]ᵣ. “m” is an integer ranging from 0 to 3. “n” is an integer ranging from 0 to 3. “p” is an integer ranging from 0 to 6. “q” is an integer of 0 or 1. “r” is an integer ranging from 1 to 4. “Ar” is an arylene group. “R⁴” is selected from the group consisting of: a hydrogen atom, a substituted or unsubstituted alkyl group having 1 to 24 carbon atoms, and a substituted or unsubstituted aromatic group having 4 to 16 carbon atoms. “M⁺” is a metal cation.

In certain embodiments, the polythiophene having at least one sulfonic acid group is shown in formula (III) or (IV) and the polyselenophene having at least one sulfonic acid group is shown in formula (V) or (VI).

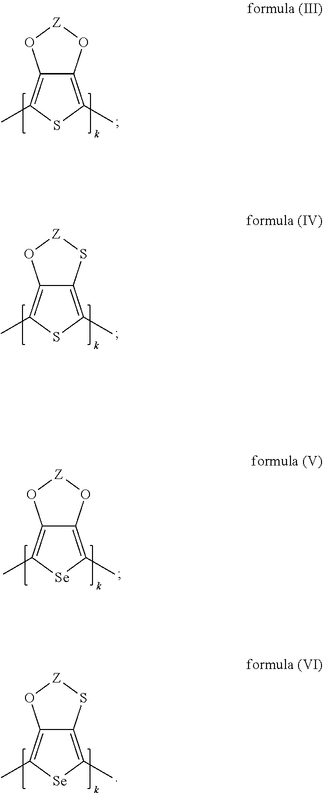

In formula (III) to formula (VI), “k” is an integer ranging from 1 to 50, and “Z” is —(CH₂)ₘ—CR²R³—(CH₂)ₙ—. “R²” is selected from the group consisting of: a hydrogen atom, —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar−SO₃⁻M⁺], and —(CH₂)ₚ—O—Ar—[(CH₂)_{q}—SO₃⁻M⁺]ᵣ. “R³” is selected from the group consisting of: —(CH₂)ₚ—O—(CH₂)_{q}—SO₃⁻M⁺, —(CH₂)ₚ—NR⁴[(CH₂)_{q}—SO₃³¹ M⁺], —(CH₂)ₚ—NR⁴[Ar—SO₃⁻M⁺], and —(CH₂)ₚ—O—Ar—[(CH₂)_{q}—SO₃⁻M⁺]ᵣ. “m” is an integer ranging from 0 to 3. “n” is an integer ranging from 0 to 3. “p” is an integer ranging from 0 to 6. “q” is an integer of 0 or 1. “r” is an integer ranging from 1 to 4. “Ar” is an arylene group. “R⁴” is selected from the group consisting of: a hydrogen atom, a substituted or unsubstituted alkyl group having 1 to 24 carbon atoms, and a substituted or unsubstituted aromatic group having 4 to 16 carbon atoms. “M⁺” is a metal cation.

In certain embodiments, the polythiophene having at least one sulfonic acid group is shown in at least one of formulas (VII) to (XII), and the polyselenophene having at least one sulfonic acid group is shown in at least one of formulas (XIII) to (XVIII).

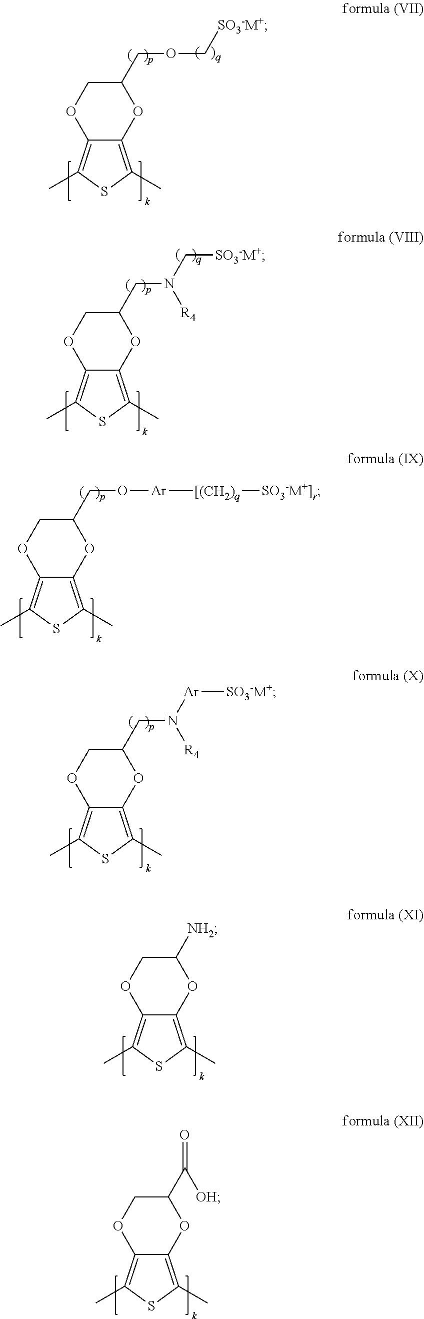

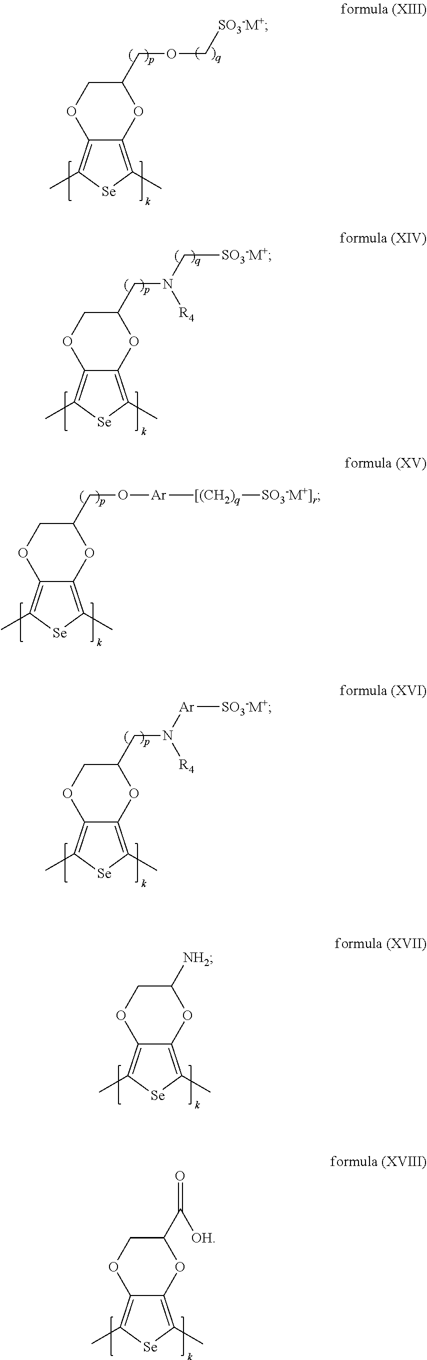

In formula (VII) to formula (XVIII), “k” is an integer ranging from 1 to 50. “Ar” is an arylene group. “R⁴” is selected from the group consisting of: a hydrogen atom, a substituted or unsubstituted alkyl group having 1 to 24 carbon atoms, and a substituted or unsubstituted aromatic group having 4 to 16 carbon atoms. “M⁺” is a metal cation. “p” is an integer ranging from 0 to 6. “q” is 0 or 1. “r” is an integer ranging from 1 to 4.

In certain embodiments, a pH value of the conductive polymer solution ranges from 3 to 8.

In certain embodiments, a viscosity of the conductive polymer solution measured at 20° C. and 100 s⁻¹ ranges from 1 mPa·s to 160 mPa·s.

In certain embodiments, the step of applying the conductive polymer solution and the step of forming the solid electrolyte are repeated for at least once.

In certain embodiments, more than 80% of the surface of the dielectric layer is covered by the solid electrolyte.

In certain embodiments, the solid electrolyte does not dissolve in water and does not swell in water.

Therefore, by virtue of “polythiophene having at least one sulfonic acid group and polyselenophene having at least one sulfonic acid group” and “an average particle size of the conductive polymer particles ranging from 0.5 nm to 50 nm”, the method for manufacturing the electrolytic capacitor of the present disclosure can enhance the electrical properties of the electrolytic capacitor.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing an electrolytic capacitor of the present disclosure;

FIG. 2 is a schematic cross-sectional view of the electrolytic capacitor of the present disclosure; and

FIG. 3 is a schematic cross-sectional view of a capacitor package structure of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

An object of the present disclosure is to provide a method for manufacturing an electrolytic capacitor having a low ESR and the electrolytic capacitor having a low ESR.

When a solid electrolyte in a capacitor is prepared from a conductive polymer solution containing conductive polymer particles whose average particle size ranges from 0.5 nm to 50 nm and whose electrical conductivity is higher than 25 S/cm, the capacitor can meet the requirements of low ESR.

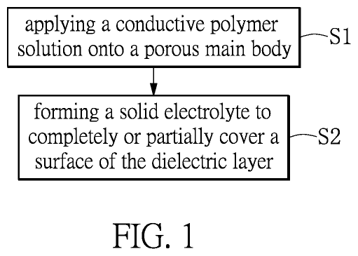

Referring to FIG. 1, a method for manufacturing the electrolytic capacitor of the present disclosure at least includes steps as follows. In step S1, a conductive polymer solution (A) is applied onto a porous main body. The porous main body at least includes a porous electrolyte body having an electrode material and a dielectric layer covering an outer surface of the electrode material. The conductive polymer solution (A) at least contains conductive polymer particles (B). In step S2, a solid electrolyte is formed to completely or partially cover a surface of the dielectric layer. An average particle size of the conductive polymer particles (B) in the conductive polymer solution (A) ranges from 0.5 nm to 50 nm. An electrical conductivity of a dry film formed from the conductive polymer particles (B) is higher than 25 S/cm.

Particle sizes of the conductive polymer particles (B) are required to be smaller than 50 nm so as to get into the porous electrode body. Apertures of the porous electrode body are larger than 500 nm. In other words, the apertures of the porous electrode body are 10 times greater than the particle sizes of the conductive polymer particles (B). A thin film with adequate conductive property is formed in the porous electrode body by the conductive polymer particles (B). A resistance of the thin film is resulted from a contact resistance between the conductive polymer particles (B). In addition, the resistance of the thin film increases along with a decrease of the particle sizes of the conductive polymer particles (B).

The particle sizes of the conductive polymer particles (B) are measured by an electron microscope.

In the present disclosure, the average particle size of the conductive polymer particles (B) in the conductive polymer solution (A) preferably ranges from 1 nm to 80 nm, more preferably ranges from 1 nm to 50 nm, and most preferably ranges from 1 nm to 25 nm.

In the present disclosure, a particle size distribution D90 of the conductive polymer particles (B) in the conductive polymer solution (A) is preferably smaller than 50 nm, more preferably smaller than 40 nm, even more preferably smaller than 30 nm, and most preferably smaller than 25 nm.

In the present disclosure, a particle size distribution D10 of the conductive polymer particles (B) in the conductive polymer solution (A) is preferably larger than 0.5 nm, more preferably larger than 1 nm, and even more preferably larger than 3 nm.

In the present disclosure, the particle size distribution D10 represents a particle size value, and 10 wt % of the conductive polymer particles (B) in the conductive polymer solution (A) has a particle size smaller than or equal to the particle size value. The particle size distribution D90 represents a particle size value, and 90 wt % of the conductive polymer particles (B) in the conductive polymer solution (A) has a particle size smaller than or equal to the particle size value.

The dry film formed from the conductive polymer solution (A) has an electrical conductivity higher than 25 S/cm, preferably higher than 50 S/cm, more preferably higher than 100 S/cm, even more preferably higher than 500 S/cm, and most preferably higher than 1000 S/cm.

In the present disclosure, an amount of metal cations in the conductive polymer solution (A) is lower than 500 mg/kg, preferably lower than 100 mg/kg, and more preferably lower than 20 mg/kg.

In the present disclosure, an amount of transition metals in the conductive polymer solution (A) is lower than 100 mg/kg, preferably lower than 10 mg/kg, and more preferably lower than 2 mg/kg.

In the present disclosure, an amount of iron metal in the conductive polymer solution (A) is lower than 100 mg/kg, preferably lower than 10 mg/kg, and more preferably lower than 5 mg/kg.

It is more advantageous for the conductive polymer solution (A) to have a low amount of metal, so that the solid electrolyte is not easy to be damaged during a formation of the solid electrolyte or during an operation of the capacitor.

In the method for manufacturing the electrolytic capacitor of the present disclosure, the electrode material is the porous main body which has high surface area, such as a porous sintered body or a roughened film The porous main body is also called an electrode body in the following description.

The electrode body covered by the dielectric layer is also called an oxidized electrode body in the following description. The term of “the oxidized electrode body” includes the electrode body covered by the dielectric layer which is not formed through an oxidation of the electrode body.

The electrode body completely or partially covered by the solid electrolyte is also called a capacitor main body in the following description.

The outer surface of the capacitor main body should be understood as a surface of an external part of the capacitor main body.

In the present disclosure, the term “polymer” represents compounds synthesized from repeating units which contain a plurality of same monomers or a plurality of different monomers.

The conductive polymer should be understood as a π-conjugated polymer having electrical conductivity after being oxidized or reduced. Preferably, the conductive polymer should be understood as a π-conjugated polymer whose electrical conductivity is in an order of magnitude of at least 1 μS/cm after being oxidized.

A material of the conductive polymer particles (B) in the conductive polymer solution (A) is preferably polythiophene having at least one sulfonic acid group (formula I), polyselenophene having at least one sulfonic acid group (formula II), or both polythiophene having at least one sulfonic acid group (formula I) and polyselenophene having at least one sulfonic acid group(formula II).

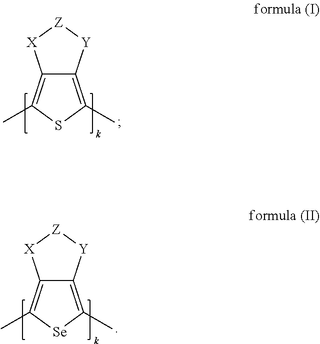

In formula (I) and formula (II), “k” is an integer ranging from 1 to 50. “X” and “Y” are each independently selected from the group consisting of: an oxygen atom, a sulfur atom, and —NR¹. “R¹” is selected from the group consisting of: a hydrogen atom, an alkyl group having 1 to 24 carbon atoms, and an aromatic group having 4 to 16 carbon atoms.

The aforesaid “alkyl group having 1 to 24 carbon atoms” can be methyl, ethyl, n-propyl, isopropyl, n-butyl, isobutyl, sec-butyl, tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethylpropyl, n-hexyl, n-heptyl, or n-octyl. Preferably, R¹ is an alkyl group having 1 to 4 carbon atoms.

In formula (I) and formula (II), “Z” is —(CH₂)ₘ—CR²R³—(CH₂)ₙ—, “m” is an integer ranging from 0 to 3, and “n” is an integer ranging from 0 to 3. In the present disclosure, “m is an integer ranging from 0 to 3” represents that “m” can be 0, 1, 2, or 3. “—(CH₂)—” represents a methylene group. In other words, a chain length of a substituted group “Z” changes according to values of “m” and “n”. For example, when both “m” and “n” are 0, the substituted group “Z” is —CR²R³—, so that “X”, “Z”, and “Y” in formula (I) along with the third and the fourth carbon atoms of a thiophene ring construct a pentagonal structure. When a sum of “m” and “n” is equal to 1, the substituted group “Z” is —(CH₂)—CR²R³—, so that “X”, “Z”, and “Y” in formula (I) along with the third and the fourth carbon atoms of the thiophene ring construct a hexagonal structure (shown in formula (VII) to (XII)). Similarly, “X”, “Z”, and “Y” in formula (II) along with the third and the fourth carbon atoms of a selenophene ring construct a hexagonal structure (shown in formula (XIII) to (XVIII)).

In the substituted group “Z”, “R²” is selected from the group consisting of: a hydrogen atom, —(CH₂)ₚ—O—(CH₂)_{q}—SO₃⁻M⁺, —(CH₂)ₚ—NR⁴[(CH₂)_{q}—SO—₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ. “R³” is selected from the group consisting of: —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR₄[Ar—SO₃⁻M⁺], and —(CH₂)ₚ—O—Ar—[(CH₂)_{q}—SO₃⁻M⁺]ᵣ. In addition, in each of “R²” and “R³”, “p” is an integer ranging from 0 to 6, “q” is an integer of 0 or 1, and “r” is an integer ranging from 1 to 4. “Ar” is an arylene group. “R⁴” is selected from the group consisting of: a hydrogen atom, a substituted or unsubstituted alkyl group having 1 to 24 carbon atoms, and a substituted or unsubstituted aromatic group having 4 to 16 carbon atoms. “M⁺” is a metal cation. In some embodiments, “M⁺” is a lithium ion, a sodium ion, a potassium ion, or an ammonium ion.

It should be noted that the conductive polymer of the present disclosure in formula (I) excludes poly(3,4-ethylenedioxythiophene) (PEDOT). Accordingly, the conductive polymer of the present disclosure is different from commercial conductive polymers, but can still have good electrical properties.

In a preferable embodiment, when “X” and “Y” in formula (I) and formula (II) are oxygen atoms, the polythiophene having at least one sulfonic acid group can be shown in formula (III), and the polyselenophene having at least one sulfonic acid group can be shown in formula (V). In another preferable embodiment, when “X” and “Y” in formula (I) and formula (II) include an oxygen atom and a sulfur atom, the polythiophene having at least one sulfonic acid group can be shown in formula (IV), and the polyselenophene having at least one sulfonic acid group can be shown in formula (VI).

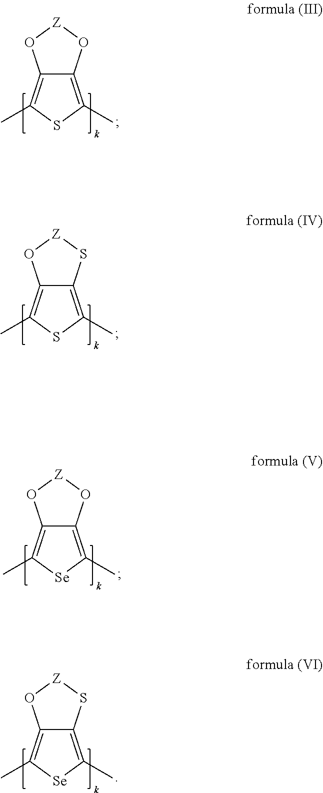

In formula (III) to formula (VI), k is an integer ranging from 1 to 50. The substituted group “Z” is —(CH₂)ₘ—CR²R³—(CH₂)ₙ—. Here, “m” is an integer ranging from 0 to 3, and “n” is an integer ranging from 0 to 3. “R²” is selected from the group consisting of: a hydrogen atom, —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ. “R³” is selected from the group consisting of: —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ. In each of “R²” and “R³”, “p” is an integer ranging from 0 to 6, “q” is an integer of 0 or 1, and “r” is an integer ranging from 1 to 4. “Ar” is an arylene group. “R⁴” is selected from the group consisting of: a hydrogen atom, a substituted or unsubstituted alkyl group having 1 to 24 carbon atoms, and a substituted or unsubstituted aromatic group having 4 to 16 carbon atoms. “M⁺” is a metal cation. In some embodiments, “M⁺” is a lithium ion, a sodium ion, a potassium ion, or an ammonium ion.

In an embodiment, when both “X” and “Y” are oxygen atoms and a sum of “m” and “n” is equal to 1, the polythiophene having at least one sulfonic acid group is shown in at least one of formulas (VII) to (XII), and the polyselenophene having at least one sulfonic acid group is shown in at least one of formulas (XIII) to (XVIII).

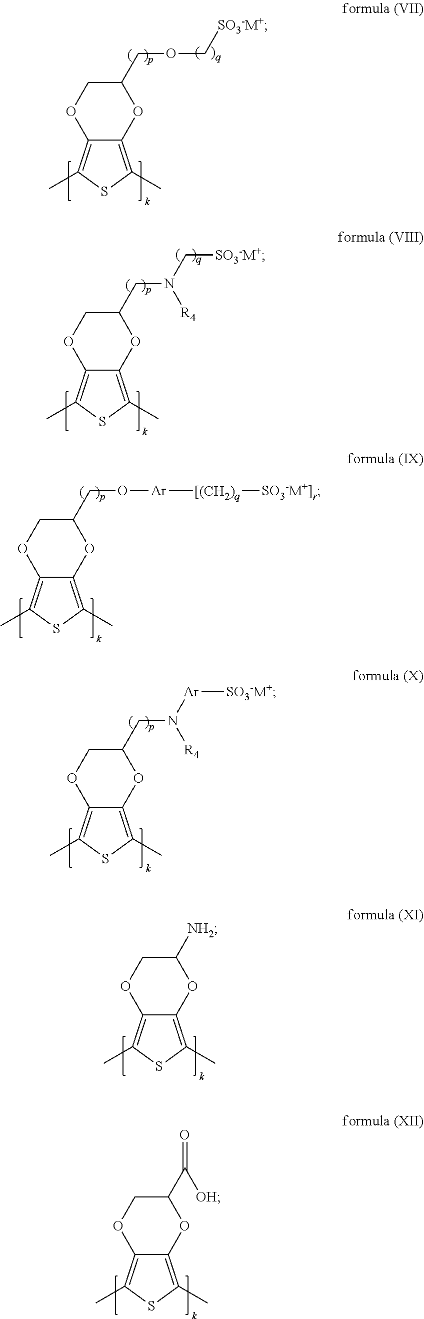

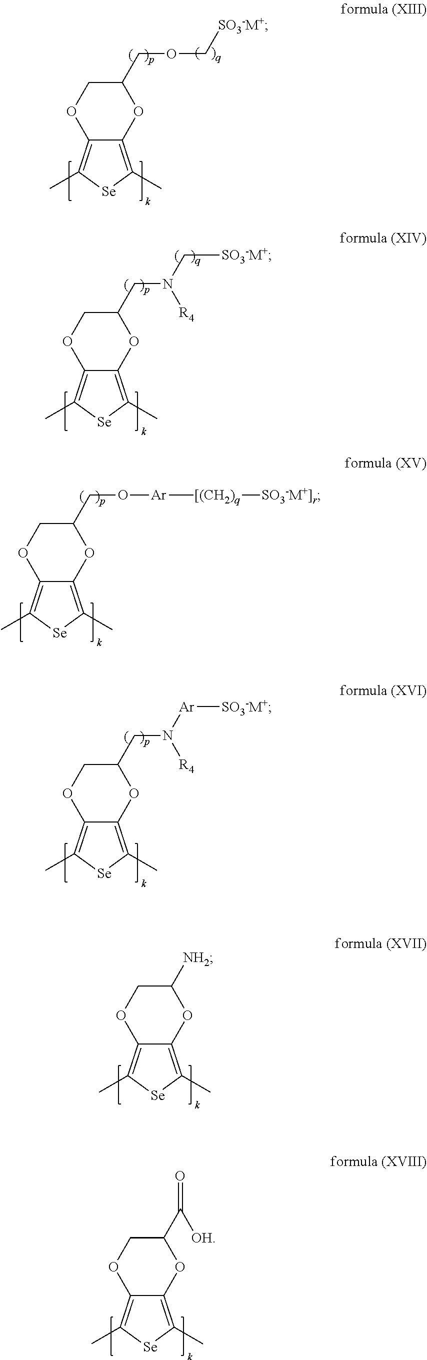

In formulas (VII) to (XVIII), k is an integer ranging from 1 to 50.

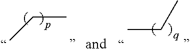

represent methylene, which is the same as “—(CH₂)—” for brevity. In each of formulas (VII) to (XVIII), “p” is an integer ranging from 0 to 6, “q” is an integer of 0 or 1, and “r” is an integer ranging from 1 to 4. “Ar” is an arylene group. “R⁴” is selected from the group consisting of: a hydrogen atom, a substituted or unsubstituted alkyl group having 1 to 24 carbon atoms, and a substituted or unsubstituted aromatic group having 4 to 16 carbon atoms. “M⁺” is a metal cation. In some embodiments, “M⁺” is a lithium ion, a sodium ion, a potassium ion, or an ammonium ion.

A pH value of the conductive polymer solution (A) can be adjusted by adding acid or base, so as to prevent the dielectric layer of the porous main body from being eroded by the conductive polymer solution (A). In an embodiment, the pH value of the conductive polymer solution (A) ranges from 1 to 14; preferably, the pH value of the conductive polymer solution (A) ranges from 1 to 8; more preferably, the pH value of the conductive polymer solution (A) ranges from 3 to 8. Moreover, the acid or base added into the conductive polymer solution (A) does not negatively influence a film-forming property of the conductive polymer solution (A). Further, even at a high temperature, such as a welding temperature, the acid or base added into the conductive polymer solution (A) does not vaporize. Therefore, the acid or base added into the conductive polymer solution (A) exists in the solid electrolyte. For example, the base can be 2-dimenthylaminoethanol, 2,2′-iminodiethanol, or 2,2′,2″-nitrilotriethanol, and the acid can be polystyrene sulfonic acid. However, the present disclosure is not limited thereto.

The viscosity of the conductive polymer solution (A) measured at 20° C. and at a shear rate of 100 s⁻¹ ranges from 0.1 to 200 mPa·s. Preferably, the viscosity of the conductive polymer solution (A) ranges from 1 to 160 mPa·s; more preferably, the viscosity of the conductive polymer solution (A) ranges from 1 to 20 mPa·s; even more preferably, the viscosity of the conductive polymer solution (A) ranges from 1 to 10 mPa·s; most preferably, the viscosity of the conductive polymer solution (A) ranges from 3 to 5 mPa·s.

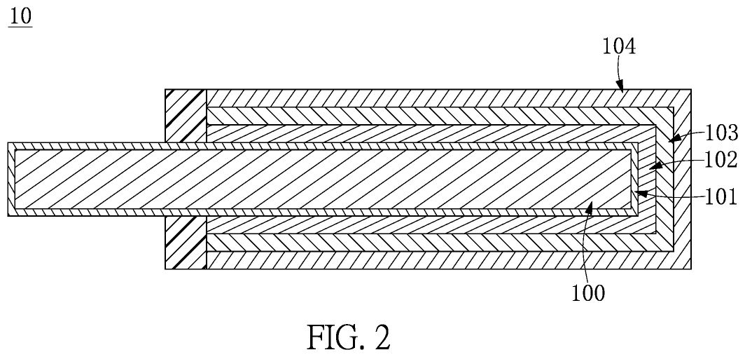

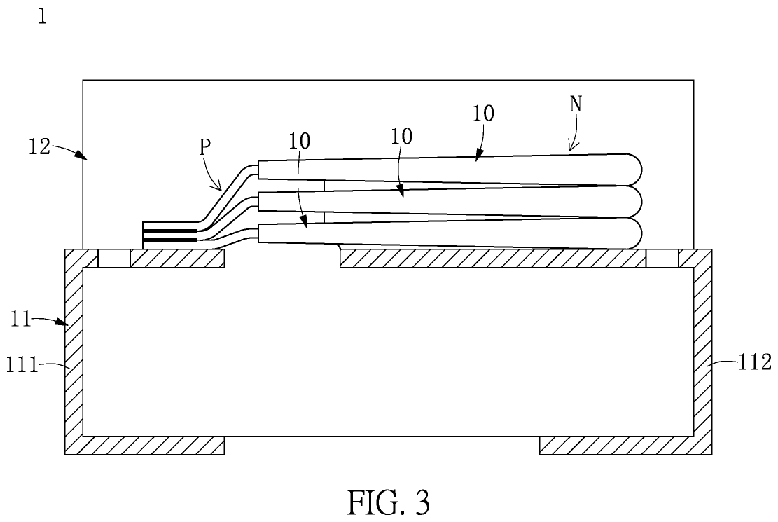

Referring to FIGS. 2 and 3, FIG. 2 is a schematic cross-sectional view of the electrolytic capacitor of the present disclosure, and FIG. 3 is a schematic cross-sectional view of a capacitor package structure of the present disclosure. Specifically, the aforesaid solid electrolyte can be applied in a cathode of a capacitor unit 10. The capacitor unit 10 shown in FIG. 2 is the capacitor unit 10 in a stacked solid electrolytic capacitor package structure 1 shown in FIG. 3.

Referring to FIG. 2, the capacitor unit 10 includes a metal foil 100, a dielectric layer 101 covering the metal foil 100, a solid electrolyte 102 covering a part of the dielectric layer 101, a carbon paste layer 103 covering the solid electrolyte 102, and a silver paste layer 104 covering the carbon paste layer 103. The specific structure of the capacitor unit 10 can be adjusted according to practical requirements. The solid electrolyte 102 is the main solid electrolyte in the capacitor unit 10.

Referring to FIG. 3, the stacked solid electrolytic capacitor package structure 1 includes a plurality of the capacitor units 10 that are sequentially stacked. The stacked solid electrolytic capacitor package structure 1 includes a conductive frame 11. The conductive frame 11 has a first conductive terminal 111 and a second conductive terminal 112 separated from the first conductive terminal 111 by a predetermined distance. The plurality of the capacitor units 10 that are sequentially stacked and electrically connected to each other have a first positive part P electrically connected to the first conductive terminal 111 of the corresponding conductive frame 11, and have a first negative part N electrically connected to the second conductive terminal 112 of the corresponding conductive frame 11. Further, the plurality of the capacitor units 10 that are sequentially stacked and electrically connected to each other are encapsulated by a package material 12, so as to form the stacked solid electrolytic capacitor package structure 1.

### Beneficial Effects of the Embodiment

In conclusion, the method for manufacturing the electrolytic capacitor of the present disclosure has technical features of “polythiophene having at least one sulfonic acid group and polyselenophene having at least one sulfonic acid group” and “an average particle size of the conductive polymer particles ranging from 0.5 nm to 50 nm”, so that the electrical properties of the electrolytic capacitor can be enhanced. Specifically, in the method for manufacturing the electrolytic capacitor of the present disclosure, by virtue of “a particle size distribution D90 of the conductive polymer particles being smaller than 50 nm” and “a particle size distribution D10 of the conductive polymer particles being larger than 0.5 nm”, the solid electrolyte can have a good electrical conductivity.

Specifically, in the method for manufacturing the electrolytic capacitor of the present disclosure, by virtue of “a viscosity of the conductive polymer solution ranging from 1 mPa·s to 20 mPa·s”, the conductive polymer solution can be well applied onto the porous main body.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing an electrolytic capacitor, comprising:
applying a conductive polymer solution onto a porous main body, wherein the porous main body includes a porous electrode body having an electrode material and a dielectric layer covering an outer surface of the electrode material; wherein the conductive polymer solution contains conductive polymer particles; and
forming a solid electrolyte to completely or partially cover a surface of the dielectric layer;
wherein a material of the conductive polymer particles includes at least one of polythiophene having at least one sulfonic acid group and polyselenophene having at least one sulfonic acid group; wherein an average particle size of the conductive polymer particles in the conductive polymer solution ranges from 0.5 nm to 50 nm, an electrical conductivity of a dry membrane formed from the conductive polymer particles is higher than 25 S/cm, and an amount of metal cations in the conductive polymer solution is less than 500 mg/kg.

2. The method according to claim 1, wherein a particle size distribution D90 of the conductive polymer particles is smaller than 50 nm.

3. The method according to claim 1, wherein a particle size distribution D10 of the conductive polymer particles is larger than 0.5 nm.

4. The method according to claim 1, wherein an amount of transition metals in the conductive polymer solution is lower than 100 mg/kg.

5. The method according to claim 1, wherein an amount of iron metal in the conductive polymer solution is lower than 100 mg/kg.

6. The method according to claim 1, wherein the polythiophene having at least one sulfonic acid group is shown in formula (I), and the polyselenophene having at least one sulfonic acid group is shown in formula (II); 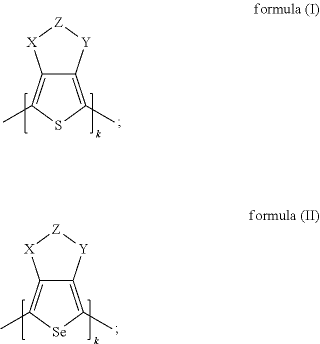
wherein X and Y are each independently selected from the group consisting of: an oxygen atom, a sulfur atom, and —NR¹; wherein R¹ is selected from the group consisting of: a hydrogen atom, an alkyl group having 1 to 24 carbon atoms, and an aromatic group having 4 to 16 carbon atoms; and k is an integer ranging from 1 to 50;
wherein Z is —(CH₂)ₘ—CR²R³—(CH₂)ₙ—; R² is selected from the group consisting of: a hydrogen atom, —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ; R³ is selected from the group consisting of: —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR₄[Ar—SO₃⁻M⁺], and —(CH₂)ₚ—O—Ar—[(CH₂)_{q}—SO₃³¹M⁺]ᵣ; m is an integer ranging from 0 to 3, n is an integer ranging from 0 to 3, p is an integer ranging from 0 to 6, q is an integer of 0 or 1, r is an integer ranging from 1 to 4, and Ar is an arylene group; R⁴ is selected from the group consisting of: a hydrogen atom, a substituted or unsubstituted alkyl group having 1 to 24 carbon atoms, and a substituted or unsubstituted aromatic group having 4 to 16 carbon atoms; and M⁺ is a metal cation.

7. The method according to claim 1, wherein the polythiophene having at least one sulfonic acid group is shown in formula (III) or (IV), and the polyselenophene having at least one sulfonic acid group is shown in formula (V) or (VI); 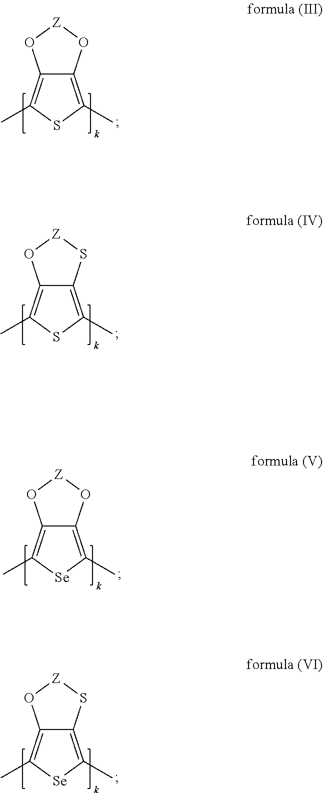
wherein k is an integer ranging from 1 to 50, and Z is —(CH₂)ₘ—CR²R³—(CH₂)ₙ—; R² is selected from the group consisting of: a hydrogen atom, —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ; R³ is selected from the group consisting of: —(CH₂)ₚ—O—(CH₂)_{q}—SO₃⁻M⁺, —(CH₂)ₚ—NR⁴[(CH₂)_{q}—SO₃⁻M⁺], —(CH₂)ₚ—NR⁴[Ar—SO₃⁻M⁺], and —(CH₂)ₚ—O—Ar—[(CH₂)_{q}—SO₃⁻M⁺]ᵣ; m is an integer ranging from 0 to 3, n is an integer ranging from 0 to 3, p is an integer ranging from 0 to 6, q is an integer of 0 or 1, r is an integer ranging from 1 to 4, and Ar is an arylene group; R⁴ is selected from the group consisting of: a hydrogen atom, a substituted or unsubstituted alkyl group having 1 to 24 carbon atoms, and a substituted or unsubstituted aromatic group having 4 to 16 carbon atoms; and M⁺ is a metal cation.

8. The method according to claim 1, wherein the polythiophene having at least one sulfonic acid group is shown in at least one of formulas (VII) to (XII), and the polyselenophene having at least one sulfonic acid group is shown in at least one of formulas (XIII) to (XVIII); 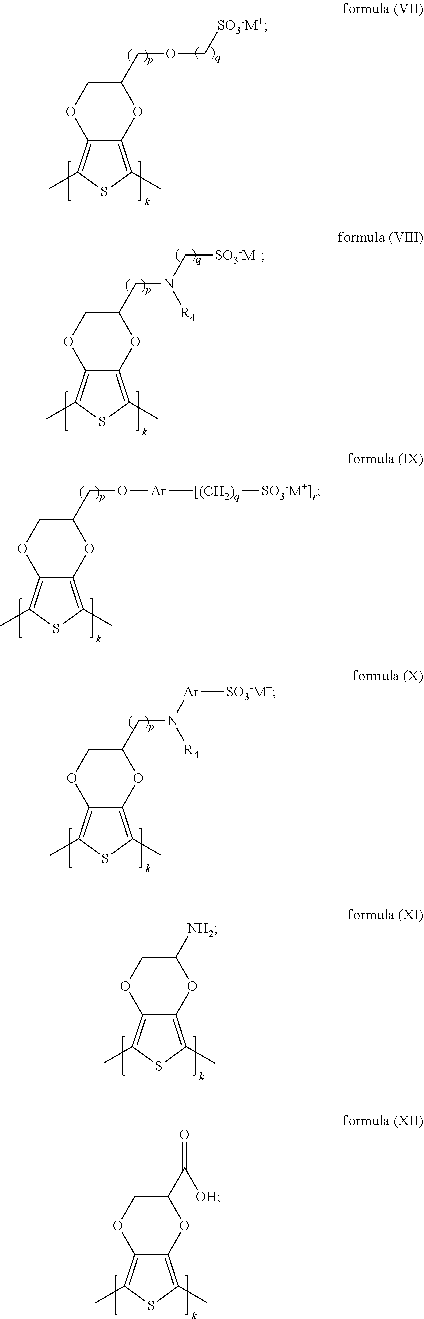 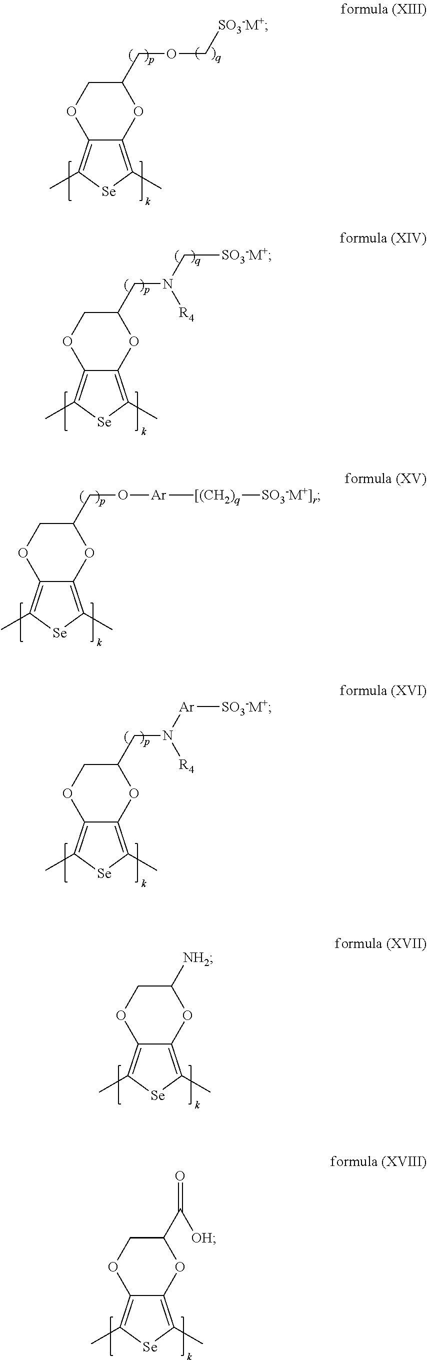
wherein k is an integer ranging from 1 to 50, and Ar is an arylene group; R⁴ is selected from the group consisting of: a hydrogen atom, a substituted or unsubstituted alkyl group having 1 to 24 carbon atoms, and a substituted or unsubstituted aromatic group having 4 to 16 carbon atoms; M⁺ is a metal cation; and p is an integer ranging from 0 to 6, q is 0 or 1, and r is an integer ranging from 1 to 4.

9. The method according to claim 1, wherein a pH value of the conductive polymer solution ranges from 3 to 8.

10. The method according to claim 1, wherein a viscosity of the conductive polymer solution measured at 20° C. and 100 s⁻¹ ranges from 1 mPa·s to 160 mPa·s.

11. The method according to claim 1, wherein the step of applying the conductive polymer solution and the step of forming the solid electrolyte are repeated for at least once.

12. The method according to claim 1, wherein more than 80% of the surface of the dielectric layer is covered by the solid electrolyte.

13. The method according to claim 1, wherein the solid electrolyte does not dissolve in water and does not swell in water.
